(19) United States
(12) Patent Application Publication
(10) Pub. No.: US 2002/0107793 A1
(43) Pub. Date: Aug. 8, 2002

(54) Electronic transaction system for the internet

(76) Inventor: Yuan-Chieh Lee, Taipei (TW)

Correspondence Address: BACON & THOMAS, 4th Floor, 625 Slaters Lane, Alexandria, VA, 22314, US

(21) Appl. No.: 09/776,669

(22) Filed: Feb. 6, 2001

(51) Int. Cl. G06F 17/60; H04K 1/00; H04L 9/00

(52) U.S. Cl. 705/40; 705/64; 705/39

(57) ABSTRACT

An electronic transaction system is used in an internet comprising at least one user site, at least one provide website and at least one bank website. The operations of the electronic transaction system comprises: when a user site transmits a request of transaction to the provider website, the user site is liked to a payment authentication server and the request is examined by the payment authentication server. Upon approval of the request, the payment authentication server is linked to the payment gateway of the bank website to request payment authorization. Upon the approval or rejection by the payment gateway of the bank website, the payment authentication server is linked to the provider website to notify said approval or rejection. Transactions between the user site and the provider website may thus be operated. The result may further notified to the user site through another linkage between the payment authentication server with the user site. In this invention, the payment authentication server serves as an intermediator among the user site, the provider website and the bank website. The transaction procedure may thus be simplified. Confidentiality of personal information of users may thus be maintained. In the embodiment of this invention, the transaction linkages are conducted by the payment authentication server.

### FIELD OF INVENTION

The present invention relates to an electronic transaction system for the internet especially to an electronic transaction system for the internet that provides necessary security functions for the electronic commerce in the internet.

### BACKGROUND OF INVENTION

Due to the wide application of the internet, electronic transactions in the internet have become popular in this society. However, security of the electronic transaction is always a topic being discussed. Not only buyers but also product and service providers are not willing to participate in the electronic commerce, unless their worry in the security problem is relived.

In the conventional art, a restrict security system to ensure the safety in the electronic commerce has been developed. Such a system primarily uses a public key and a private key to ensure the security of the electronic transaction. The public key is a code that is allowed to provide to others and the private key is a code to be kept confidential by its user. Under the security system, information to be transmitted in a communication channel may be secured with a security code relatively to a public key or a private key and decoded by receiver of the information with a corresponding private key or public key, returning to the original information.

In the above-said security system, the coding and the decoding processes made the electronic transaction very complicated. FIG. 3 shows the flow chart of an electronic transaction under the conventional electronic commerce system. As shown in this figure, when a user clicks a product in a provider website at 301, a transaction mode is provided. At 302 the provider website asks the user to input his/her credit card or bank card number, valid date and other information. At 303 the input information is coded by the personal computer of the user with a private key and a public key, such the information becomes a secured information. At 304 the secured information is transmitted to the provider website.

In this stage, at 305 the provider website links itself with the website of the issuing back of the credit card or the bankcard. The bank website asks the provider website to provide its security code at 306. At 307 the bank website uses the public key to decode the provided security code and verify. After the verification, at 309, a notice is transmitted to the provider website and user's personal information is requested. At 310 the provider website transmits the secured card number, valid date, security code and other information to the bank website. At 311 the bank website decodes the transmitted information with the public key and verify. After the verification, the transaction requested by the user is permitted and the result is provided to the provider at 312. At 313, the provider website transmits the result to the user and enters into the shipping stage. In the above steps, the notices generated by the bank and the provider may be secured information. The transmission and decoding of the secured information may be conducted according to the above-said approaches.

In the above-described transaction, the information is exchanged among three parties. As a result, a waste in time and processing costs is found. In addition, the personal information of the user is first transmitted to the provider website. During the transmission, the information is exposed to the access of the provider and third parties, although the information has been secured. In order to ensure the security of the information, necessary means are required. Costs in the electronic commerce is further increased.

It is thus necessary to provide a simplified electronic transaction system for the internet that can provide a simplified electronic transaction procedure to reduce time and cost in the electronic transaction.

It is also necessary to provide a novel electronic transaction system for the internet so that electronic transaction with higher security may be realized.

### OBJECTIVES OF INVENTION

The objective of this invention is to provide a simplified electronic transaction procedure to reduce time and cost in the electronic transaction.

Another objective of this invention is to provide a novel electronic transaction system for the internet so that electronic transaction with higher security may be realized.

### SUMMARY OF INVENTION

According to the electronic transaction system for the internet of this invention, the electronic transaction system is used in an internet comprising at least one user site, at least one provide website and at least one bank website. The controlling operations of the electronic transaction system comprises: when a user site transmits a request of transaction to the provider website, the user site is liked to a payment authentication server and the request is examined by the payment authentication server. Upon approval of the request, the payment authentication server is linked to the payment gateway of the bank website to request payment authorization. Upon the approval or rejection by the payment gateway of the bank website, the payment authentication server is linked to the provider website to notify said approval or rejection. Transactions between the user site and the provider website may thus be operated. The result may further notified to the user site through another linkage between the payment authentication server with the user site. In this invention, the payment authentication server serves as an intermediator among the user site, the provider website and the bank website. The transaction procedure may thus be simplified. Confidentiality of personal information of users may thus be maintained. In the embodiment of this invention, the transaction linkages are conducted by the payment authentication server.

The above and other objectives and advantages may be clearly understood from the detailed description by referring to the following drawings.

### BRIEF DESCRIPTION OF DRAWINGS

FIG. 1 illustrates the system diagram of the electronic transaction system for the internet of this invention.

FIG. 2 shows the flow chart of the electronic transaction system for the internet of this invention.

FIG. 3 shows the system diagram of a conventional electronic transaction system for the internet.

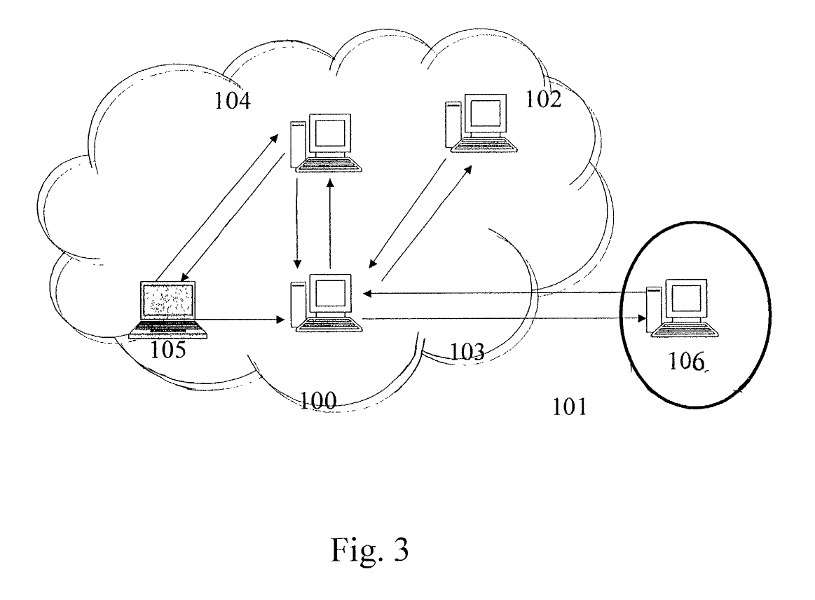

### DETAILED DESCRIPTION OF INVENTION

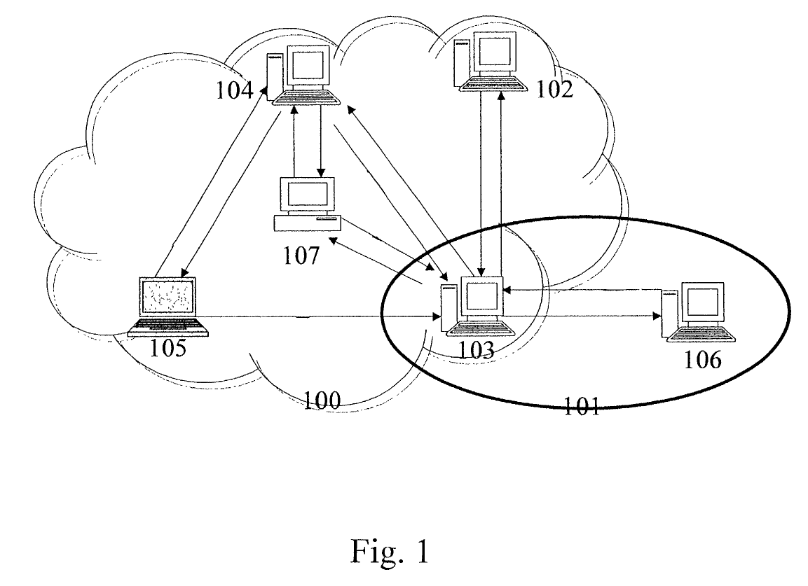

In the followings, the electronic transaction system for the internet of this invention will be described by referring to FIG. 1. FIG. 1 illustrates the system diagram of the electronic transaction system for the internet of this invention.

As shown in FIG. 1, the electronic transaction system for the internet is used in the internet 100. The internet 100 comprises: at least one user site 105 that may be linked to the internet 100; at least one provider website 104 to promote products, services or information in the internet 100; at least one bank website 101 to provide payment and other banking services; and an authentication center 102 to provide authentication services to bank websites 101, provider websites 104 and user sites 105. The authentication services and its functions and operations are already known to those skilled in the art. Detailed description thereof is thus omitted.

In the present invention, a payment authentication server 103 is provided. The payment authentication server 103 is an electronic transaction server independent from the bank website 101, the provider site 104 and the user site 105. The functions of the payment authentication server 103 include intermediation, control and operation of the examination and the transmission of information during an electronic transaction. At the bank website 101, a payment gateway 106 may be provided to handle the transactions and data transmissions between the bank website 101 and its external sites, including the payment authentication server 103, so that security in the electronic transaction may be ensured. In order to further enhance the security of the electronic commerce, a firework (not shown) may also be provided between the bank website 101 and the payment gateway 106.

Before any electronic transaction may be started, the payment authentication server 103 shall first obtain an authorization from the authentication center 102. In doing so, the payment authentication server 103 submits an application with the authentication center 102 to be authorized to receive information coded with SSL. Upon such application, the authentication center 102 provides a necessary authorization to the payment authentication server 103. After the authorization the payment authentication server 103 will have the right to provide to the provider website 104 and the user site 105 payment authentication and other authentication services. The authentication of the payment authentication server 103 may be conducted in any approach as already known to those skilled in the art.

Before the provider website 104 and the user site 105 may execute an electronic transaction in the electronic transaction system for the internet of this invention, pre-authentication of the provider website 104 and the user site 105 with the payment authentication server 103 is necessary. When the provider website 104 submits an application for pre-authentication, a batch of relative information including email address, name, ID No. and other data representing the provider website 104 or the provider is provided to the payment authentication server 103. After examination, the payment authentication server 103 generates a provider series number, labels the batch of information and transmits the series number to the provider website 104, with which the provider website 104 may execute its electronic transaction accordingly. The procedure of pre-authentication to the bank website 101 and the user site 105 is similar to that to the provider website 104.

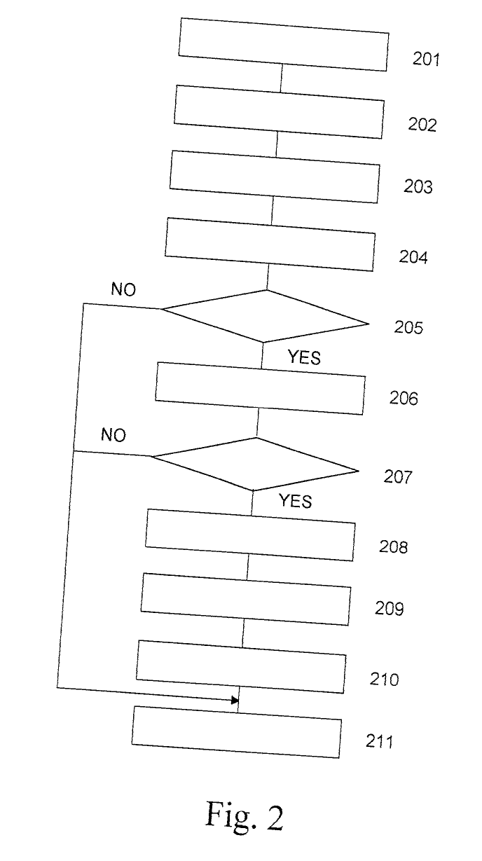

In the followings, procedures of the electronic transaction in the electronic transaction system for the internet of this invention will be given. FIG. 2 shows the flow chart of the electronic transaction of the electronic transaction system for the internet of this invention.

As shown in this figure, when an electronic transaction takes place, at 201 the user site 105 links to the provider website 104 and transmits to the provider website 104 its user series number, requesting a transaction. In this step, the request is made to the provider website 104 from the user site 105 when user of the user site 105 clicks on an icon representing a product, service or information to be purchased. When making such a request, information including internet address of the user site 105, item and quantity to purchase, price and name of banker, is transmitted to the provider website 104 along with the series number (membership number) of the user or user site 105. In the embodiment of this invention, confidential information of the user or user site, such as bank account, credit card number, valid date and pass words, is not transmitted to the provider website 104.

At 202 the provider website 104 forwards the received request, along with the received information and the series number and internet address of the provider website 104, to the payment authentication server 103, requesting for authentication. At 203, upon receipt of such a request, the payment authentication server 103 links itself to the user site 105 and starts to examine the received information with the enrolled information of the provider website 104 and the user site 105. When the received information matches with the enrolled information, at 204 the payment authentication server 103 requests the user site 105 to provide confidential information to the payment authentication server 103. The requested information includes bank account number, credit card number, bank card number, passwords and/or other information necessary in the electronic transaction. At 205 the user site 105 inputs the requested information and the input information is examined by the payment authentication server 103. After approval of the payment, the payment authentication server 103 links itself to the payment gateway 106 and transmits a request for authorization of payment to the payment gateway 106. In forwarding such a request, the confidential information of the user or user site is transmitted to the payment gateway 106 for examination. At 207 the payment gateway 106 examines the credit card/bank card number, the valid credit/deposit and other necessary conditions of authorization and generates a result of examination. At 208 the payment gateway 106 transmits the result to the payment authentication server 103 and records the requested transaction. When the request is approved, the result information contains an authorization code. When the request is rejected, the result contains a failure code. At 209 the payment authentication server 103 links itself to the provider website 104, according to the authorization/failure code, the series and the internet address of the provider website 104, and transmits the result of authorization for payment to the provider website 104. Thereafter, at 210 the payment authentication server 103 links the provider website 104 to the user site 105. At 211 the provider website 104 determines whether the transaction between it and the user site 105, as previously requested by the user site 105, is successful, according to the information represented by the authorization/failure code. At 212, the result is transmitted to the user site 105 by the provider website 104 and necessary actions, such as shipping of the purchased product, service or information, will be taken by the provider website 104.

In the above transaction, the result may also be transmitted to the user site 105 by the payment authentication server 103.

When it is necessary for the provider website 104 to search records of its electronic transactions, or when it requests the bank website 101 to make payments, such a request is made to the payment authentication server 103. Upon such a request, the provider website 104 links itself to the payment authentication server 103 and input its series number and other necessary information. Upon receipt of the request and the attached information, the payment authentication server 103 examines the received information and, upon approval, transmits the request to the payment gateway 106, along with necessary information. The payment gateway 106, after examination, obtains requested information from the bank website 101 and transmits the obtained information to the payment authentication server 103. The requested information is then transmitted to the provider website 104 by the payment authentication server 103.

In the above transaction, all information as transmitted may be information encoded with the public key and the private key. No matter what the information could be, the confidential information of the user site 104 or of the provider website 104 is not transmitted to the other party of the electronic transaction. In other words, during the transaction, no confidential information is transmitted between any two of the user site, the provider website and the bank website. As a result, it is ensure that no confidential information is given to the other party of a transaction. Another advantage of such a transaction is that examination procedures of passwords and other necessary information in authorization, authentication are greatly reduced. It is obvious that security and efficiency in the electronic transaction may be improved.

As the present invention has been shown and described with reference to preferred embodiments thereof those skilled in the art will recognize that the above and other changes may be made therein without departing form the spirit and scope of the invention.

What is claimed is:

1. An electronic transaction system for the internet, to be used in an internet system comprising:
at least one internet user site equipped with an internet accessible computer;
at least one provider website to provide products, services and/or information in said internet system;
at least one bank website to allow access by internet users, including said internet user site, to request payments; and
a payment authentication server to examine requests and information and to generate results of examination;
characterized in that said electronic transaction system operates a request of transaction in a method comprising the following steps:
upon said provider website's receipt of a request of transaction by said internet user, linking said user site to said payment authentication server;
said payment authentication server asking said user site to input necessary information for examination;
said payment authentication server examining said input information according enrolled information of said user site;
upon approval of examination by said payment authentication server, lining said payment authentication server to said bank website; otherwise, linking to said provider website and transmitting to said provider website result of said examination;
after having linked to said bank website, said payment authentication server requesting said bank website to authorize payments to said provider site by transmitting said input information to said bank website;
said bank website examining said request by comparing said input information with enrolled information of said user site and generating a result of said examination;
said bank website transmitting said result of examination to said payment authentication server; and
said payment authentication server linking to said provider website and transmitting said result of examination to said provider said provider website.

2. The electronic transaction system for the internet according to claim 1, wherein said electronic transaction system for the internet further links to said user site and transmits said result of examination to said user site after said result of examination is transmitted to said provider website.

3. An electronic transaction system for the internet, to be used in an internet system comprising:
at least one internet user site equipped with an internet accessible computer;
at least one provider website to provide products, services and/or information in said internet system; and
at least one bank website to allow access by internet users, including said internet user site, to request payments;
characterized in that said electronic transaction system for the internet comprises a payment authentication server to examine requests and information and to generate results of examination; a user database to store enrollment data of a plurality of users; and a provider database to store enrollment data of a plurality of provider sites; and that said payment authentication operates a request of transaction in a method comprising the following steps:
upon receipt of said provider website's input of a request of transaction by said internet user, linking to said user site;
asking said user site to input necessary information for examination;
examining said input information according enrolled information of said user site;
upon approval after said examination, linking to said bank website; otherwise, linking to said provider website and transmitting to said provider website result of said examination;
after having linked to said bank website, requesting said bank website to authorize payments to said provider site by transmitting said input information to said bank website;
receiving result of said examination from said bank website; and
linking to said provider website and transmitting said result of examination to said provider said provider website.

4. The electronic transaction system for the Internet according to claim 3, wherein said payment authentication server further links to said user site and transmits said result of examination to said user site after said result of examination is transmitted to said provider website.
